(19) United States
(12) Patent Application Publication
(10) Pub. No.: US 2014/0055457 A1
(43) Pub. Date: Feb. 27, 2014

(54) PIXEL-BASED GRAPHICAL VISUALIZATION INCLUDING A PEAK DETECTION RING

(71) Applicants: Ming C. Hao, Palo Alto, CA (US); Manish Marwah, Palo Alto, CA (US); Sebastian Mittelstaedt, Konstanz (DE); Halldor Janetzko, Steisslingen (DE); Cullen E. Bash, Los Gatos, CA (US); Umeshwar Dayal, Saratoga, CA (US); Meichun Hsu, Los Gatos Hills, CA (US); Daniel Keim, Konstanz (DE); Chandrakant Patel, Fremont, CA (US)

(72) Inventors: Ming C. Hao, Palo Alto, CA (US); Manish Marwah, Palo Alto, CA (US); Sebastian Mittelstaedt, Konstanz (DE); Halldor Janetzko, Steisslingen (DE); Cullen E. Bash, Los Gatos, CA (US); Umeshwar Dayal, Saratoga, CA (US); Meichun Hsu, Los Gatos Hills, CA (US); Daniel Keim, Konstanz (DE); Chandrakant Patel, Fremont, CA (US)

(21) Appl. No.: 13/592,747

(22) Filed: Aug. 23, 2012

(51) Int. Cl. G06T 11/20

(52) U.S. Cl. 345/440

(57) ABSTRACT

A method executed by a system having a processor includes arranging pixels representing attributes into a plurality of rings. Each ring contains pixels representing a time series of attribute values for a respective one of the attributes. The method further includes providing a peak detection ring. The peak detection ring includes visual indicators for indicating a location of at least one peak in an attribute in the plurality of rings.

### BACKGROUND

An enterprise can collect a relatively large amount of data records over time. Such data records can be visualized in graphical visualizations. However, visualizing relatively large amounts of data records can be associated with various challenges.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings:

FIG. 1 illustrates an example of a graphical visualization that includes discrete data rings of pixels, including a peak detection ring according to some implementations;

FIG. 2 is a flow diagram of a process of providing a graphical visualization according to some implementations;

FIG. 3 is a flow diagram of a process of providing a peak detection ring according to some implementations;

FIG. 4 illustrates an example of a time series of an attribute;

FIG. 5 illustrates the time series of FIG. 4 after identifying peaks;

FIG. 6 illustrates calculating and projecting the significance of peak points detected in data rings onto a peak detection ring, according to some implementations;

FIG. 7 is a block diagram of an example system incorporating some implementations.

Use of the same reference numbers in different figures may indicate similar or identical elements.

### DETAILED DESCRIPTION

An enterprise (e.g. business concern, educational organization, government agency, individual, etc.) can collect a relatively large amount of data records over time. For example, an enterprise can receive measurements from various monitoring devices in a system, such as a network of devices, a data center, a system of storage devices, and so forth. The collected measurements can include performance measurements, such as utilization of computer servers, utilization of storage devices, data rates through communication devices, and so forth. In other examples, data records can include other types of data, such as financial data (e.g. revenue, profit, etc.) of the enterprise, user feedback (expressing user sentiments regarding a product or service offering, for example) collected by the enterprise, data relating to a physical infrastructure (e.g. temperature, power utilization, water utilization, etc.), and so forth.

The collected data records can be in the form of time series or other types of data collections, often sequential data collections. A data record can generally refer to a representation of data that can have one or multiple attributes. One example of an attribute can be a time attribute, which can indicate a time associated with the data record (e.g. time that the data was acquired or received). Another attribute can represent a value that is being measured, such as processor utilization, storage utilization, temperature, data rate, profit, revenue, user sentiment, and so forth.

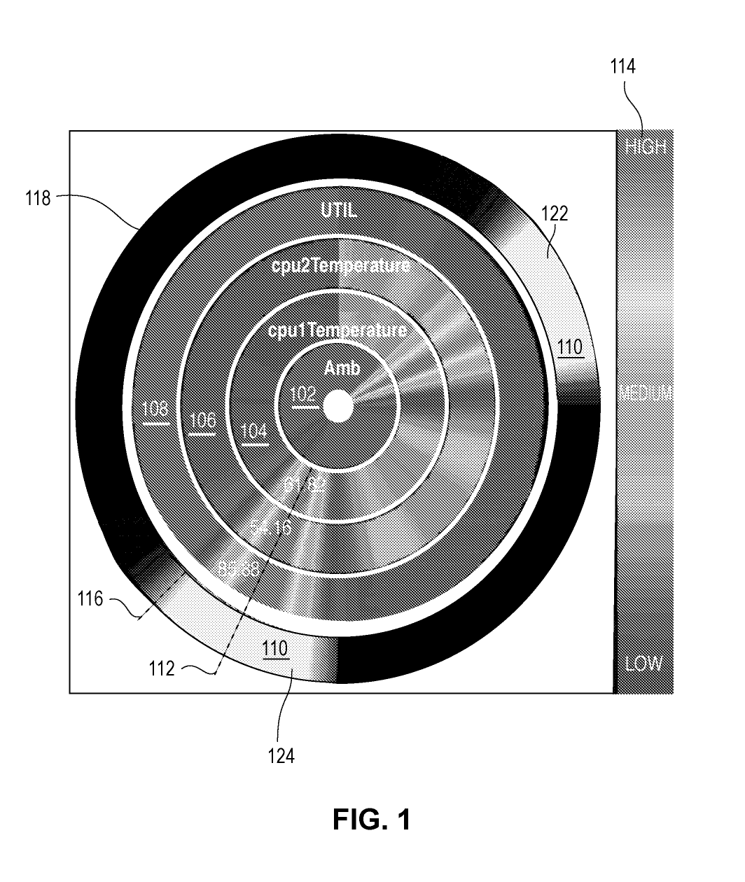

In some cases, it may be desirable to visualize significant peaks among two or more attributes associated with the data records at various time intervals. Recognizing such peaks in a relatively large volume of data records can be challenging. In accordance with some implementations, a ring-based graphical visualization, such as illustrated in FIG. 1, is provided that includes discrete annular data rings 102, 104, 106, and 108 of pixels. The multiple discrete annular data rings 102, 104, 106, and 108 correspond to respective different attributes. The ring-based graphical visualization can also be referred to as a multi-variable or multi-attribute ring-based graphical visualization.

The pixels within each discrete data ring represent corresponding attributes in respective time intervals (e.g. a time interval can be a measurement interval during which a measurement can be taken to provide a value of a data record). Note that a discrete annular data ring can be generally circular in shape, though other shapes are possible.

In addition to the discrete annular data rings that include pixels representing various attributes, a peak detection ring 110 may be provided to indicate significant peaks among the attributes represented in the discrete rings 102, 104, 106, and 108.

In a specific example according to FIG. 1, the different attributes represented by corresponding ones of the discrete data rings 102, 104, 106, and 108 are: ambient temperature (Amb), a temperature of a first CPU (cpu1Temperature), a temperature of a second CPU (cpu2Temperature), and system utilization (Util). The ambient temperature (Amb) can represent a temperature in an enclosure of a system, such as a rack in a data center, a computer system, storage system, communications system, and so forth. The system can include multiple central processing units (CPUs), and temperature measurements can be collected for the respective multiple CPUs. In the example of FIG. 1, two temperature measurements are collected for two respective CPUs, cpu1Temperature and cpu2Temperature. Additionally, utilization of the system can be measured, and represented as Util. Utilization can refer to a collective utilization of the CPUs of the system, for example. The values illustrated in the data rings may have units—for example, ambient temperature Amb may have units of ° C. In contrast, the peak detection ring 110 described below indicates the significance of peaks in the data rings; therefore, the information displayed in the peak detection ring has no units.

Within each discrete ring 102, 104, 106, or 108, the pixels are temporally arranged according to the time intervals of the attributes being represented by the discrete data ring. For example, in ring 102, the pixels are arranged according to time intervals corresponding to the data records that contain the Amb attribute; in ring 104, the pixels are arranged according to time intervals corresponding to the data records that contain the cpu1Temperature attribute, and so forth. Stated differently, each of the discrete rings 102, 104, 106, and 108 represents a time series of values of a corresponding different attribute. The time intervals across all the discrete data rings are aligned.

Each pixel can represent a data record for a particular time interval (e.g., minute). Assuming that each discrete data ring represents attribute values collected over a day, then there can be 1,440 (24×60) pixels in each discrete data ring, to represent the 1,440 minutes within each day. In a different example, each pixel can represent a data record for a second—in such example, a discrete data ring that represents attribute values collected over a day would include 86,400 pixels, to represent the 86,400 seconds within each day.

Additionally, the pixels across different annular data rings are temporally aligned such that along a given radial axis in the graphical visualization 100, the pixels in the different annular rings 102, 104, 106, and 108 represent the same time interval. For example, temporally aligning the pixels along a radial axis across different annular rings can refer to the fact that the pixels in the different discrete data rings along the radial axis represent data records at the same minute. For example, a radial axis 112 depicted in FIG. 1 can correspond to hour 13 (13:00, or 1 PM). The pixels in the discrete annular data rings 102, 104, 106, and 108 that are along the radial axis 112 represent data records for hour 13, minute 0 (13:00) for their respective four attributes. At 13:00, as illustrated in FIG. 1, cpu1Temperature has a value of 61.82 as shown in data ring 104, cpu2Temperature has a value of 54.16 as shown in data ring 106, and Util has a value of 85.88 as shown in data ring 108.

The pixels in the discrete data rings 102, 104, 106, and 108 are assigned corresponding visual indicators, which can be color, as illustrated in FIG. 1, or gray-scale. A color scale 114 is illustrated in FIG. 1 and maps different colors to different values of the attribute that is being depicted. Pixels in a discrete data ring representing a corresponding time series of attribute values at corresponding time intervals are assigned different colors (or other visual indicators, such as different brightness) to allow changes of the corresponding attribute over time to be observed.

For example, in ring 102, different color is assigned to pixels according to different values of the Amb attribute. A red pixel indicates a higher ambient temperature, a blue pixel indicates a lower ambient temperature, and a green pixel indicates an ambient temperature between red and blue. Though FIG. 1 is illustrated in color, gray-scale can be used to illustrate different attributes. For example, lighter pixels may represent a higher ambient temperature and darker pixels may represent a lower ambient temperature. At 13:00, as illustrated in FIG. 1 along radius 112, the pixels in data rings 104, 106, and 108 are red, indicating that the values in these data rings are high.

In addition to the discrete annular data rings 102, 104, 106, and 108 that contain pixels representing various attributes, the ring-based graphical visualization can also include the peak detection ring 110. In some examples, as illustrated in FIG. 1, the peak detection ring 110 is provided as an outermost ring around the discrete data rings that contain pixels representing attributes. In other examples, instead of providing the peak detection ring 110 as the outermost ring, the peak detection ring 110 can be provided as an innermost ring, or alternatively, the peak detection ring 110 can be provided between two of the discrete data rings containing pixels representing attributes.

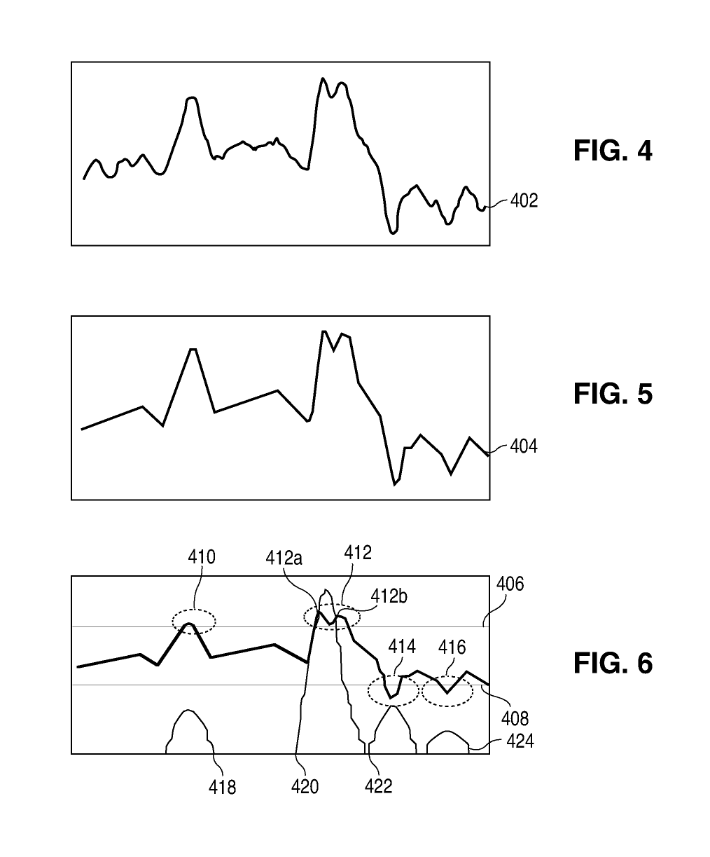

The peak detection ring 110 has visual indicators for indicating the location of significant peaks in the attributes represented by the pixels in the discrete data rings 102, 104, 106, and 108. In some implementations, the visual indicators of the peak detection ring 110 include different brightness for indicating different degrees of significance of the peaks in the discrete data rings 102, 104, 106, and 108. One example of determining the significance of peaks in the discrete rings 102, 104, 106, and 108 is described below in reference to FIGS. 4, 5, and 6. For example, significant peaks may include a position with a high density of peaks across one or more than one of discrete data rings 102, 104, 106, and 108, and/or a high value peak in a single one of discrete data rings 102, 104, 106, and 108.

The brightness of the peak detection ring 110 at any given annular position in the peak detection ring 110 presents the degree of significance of one or more peaks at a corresponding time interval. In FIG. 1, it is assumed that peak detection ring 110 indicates the significance of peaks across all of the four discrete data rings 102, 104, 106, and 108 illustrated in FIG. 1. Such a peak detection ring 110 provides for a global view of significant peaks across multiple attributes (displayed in multiple discrete data rings). In other examples, the peak detection ring 110 can indicate significant peaks across less than all of the four discrete data rings 102, 104, 106, and 108 illustrated in FIG. 1.

In some implementations, a user can select any one or more of the attributes of the discrete data rings for significant peak detection. For example, the user can select two attributes, select three attributes, and so forth. The selection can be accomplished using any of various techniques, such as drawing a selection box, entering the attributes into a control menu, clicking on the discrete data rings, and so forth.

As an example, the brightness of the peak detection ring 110 at the annular position corresponding to the radial axis 112 represents the significance of one or more peaks at the time interval corresponding to radial axis 112 (time 13:00). A higher brightness on peak detection ring 110, for example at radial axis 112, indicates a more significant peak area, e.g. a higher density of peaks within a single ring and/or across multiple rings or a higher value single peak. A lower brightness on peak detection ring 110, for example at region 116, indicates a less significant peak area. Other visual indicators besides brightness, such as color, can be used.

Where there are no significant peaks, the corresponding portions of peak detection ring 110 can be faded. Fading a portion of the peak detection ring 110 can refer to making that portion darker as compared to other portions of the peak detection ring 110 that indicate significant peaks among the attributes. In some examples, the faded portion of the peak detection ring 110 can be made black, such as in portion 118. Fading areas without significant peaks allows an analyst to better focus on areas with significant peaks.

In the example of FIG. 1, two regions of relatively significant peaks are indicated, a first region 122 and second region 124. In region 122, the pixels in the discrete data rings 102, 104, and 106 are red, orange, or yellow, indicating relatively high values in the ambient temperature, the first CPU temperature, and the second CPU temperature at the time intervals in region 122. In region 124, the pixels in the discrete data rings 104, 106, and 108 are red, orange, or yellow, indicating high values in the first CPU temperature, the second CPU temperature, and the utilization at the time intervals in region 124. Accordingly, regions 122 and 124 are areas with a high density of peaks across multiple data rings.

FIG. 1 shows that the discrete rings 102, 104, 106, 108, and 110 are separated from each other by visible boundaries, in the form of dark circles between adjacent rings. Any suitable boundary may be used. The boundaries allow a user to easily recognize groups of pixels for corresponding different attributes and the peak detection ring, though in some examples there are no boundaries between adjacent rings.

Although just one peak detection ring 110 is illustrated in FIG. 1, in other examples, a ring-based graphical visualization can include multiple peak detection rings. Each of the multiple peak detection rings can represent significant peaks among attributes of a corresponding different subset of the attributes represented by the discrete data rings in the graphical visualization.

A user can select a particular pixel in any of the discrete data rings 102, 104, 106, and 108 to obtain additional information regarding the pixel (a “drill-down” operation). For example, when a user moves a cursor over a particular pixel, a pop-up box can be displayed to depict additional information regarding the selected pixel. Additionally, a user can zoom into a particular portion of the ring-based graphical visualization to obtain a larger view of the portion.

By using a peak detection ring such as the peak detection ring 110 illustrated in FIG. 1, a user can locate regions with high value peaks or with a high density of peaks within one attribute and/or across multiple attributes. The visual indicators in the peak detection ring 110 allow the user to focus on time intervals with significant peaks, which may correspond to abnormal or unwanted behavior.

FIG. 2 is a flow diagram of a process according to some implementations. In block 202, pixels representing attributes of data records are arranged into discrete data rings in a graphical visualization, such as the graphical visualization illustrated in FIG. 1. The discrete data rings may correspond to different ones of the attributes.

In block 204, a peak detection ring such as the peak detection ring 110 of FIG. 1 is provided in addition to the discrete rings. The peak detection ring includes visual indicators for indicating a location of at least one peak in an attribute in the discrete data rings.

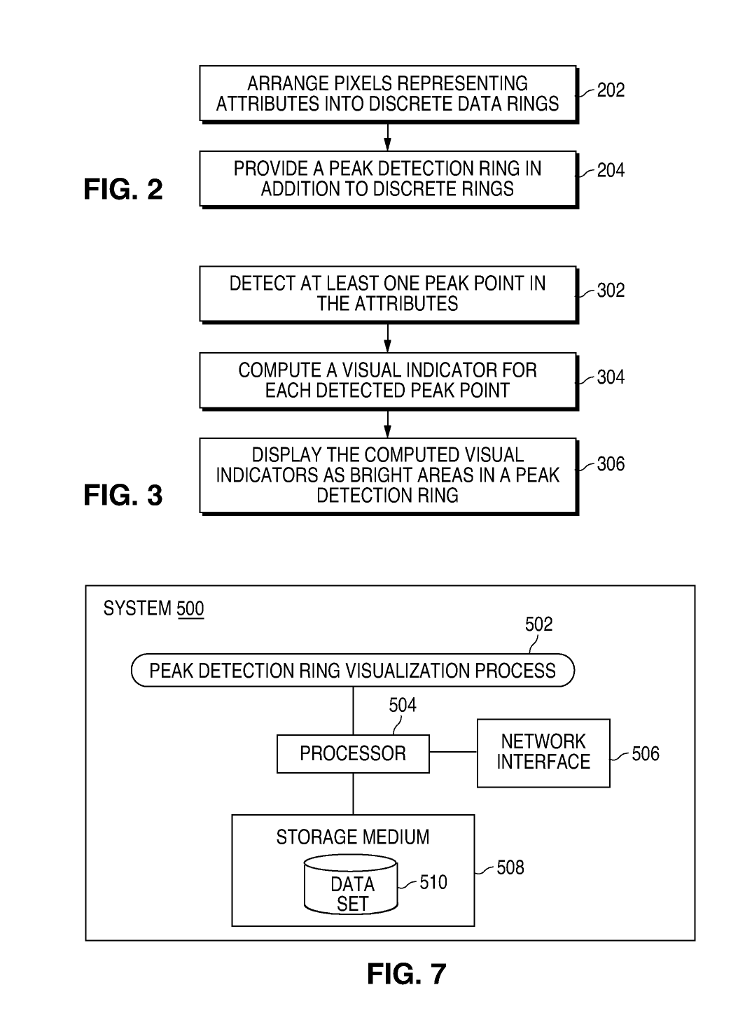

FIG. 3 is a flow diagram of a process for providing a peak detection ring according to some implementations. In block 302, at least one peak point in an attribute is detected. In some examples, peak points that are higher or lower than one or more thresholds are detected in block 302. In some examples, one or more thresholds are defined by user selection. The selection can be accomplished using any of various techniques, such as entering the threshold value(s) into a control menu for each data ring.

In block 304, a visual indicator is computed for each detected peak point.

In block 306, the computed visual indicators are displayed as bright areas in a peak detection ring, such as peak detection ring 110 illustrated in FIG. 1.

FIGS. 4, 5, and 6 illustrate an example of detecting peak points and computing a visual indicator for the detected peak points. FIG. 4 illustrates a time series of an attribute of a data record 402. In FIG. 5, the raw data stream of FIG. 4 is smoothed, i.e. reduced to a number of peak points 404.

In FIG. 6, significant peak areas are detected. For example, in FIG. 6, peak areas are significant if they include peaks that are above the threshold defined by line 406 or below the threshold defined by line 408. The significant peak areas detected in FIG. 6 may be detected by any suitable technique including, for example, a variant of the Douglas Peucker algorithm that uses thresholds. The Douglas Peucker algorithm is described in D. Douglas and T. Peucker, “Algorithms for the reduction of the number of data points required to represent a digitized line or its caricature”, The Canadian Carthographer 10(2), 112-122 (1973). Thresholds 406 and 408 may be user defined in some examples. Only one threshold in a data ring may be used, such that significant peaks are above or below a single threshold in some implementations. Different thresholds may be used in different discrete data rings.

FIG. 6 illustrates four significant peak areas 410, 412, 414, and 416. Peak areas 410 and 412 include peaks that are above threshold 406. Peak area 412 includes two discrete peaks 412a and 412b that are close in time and both above threshold 406. Peak areas 414 and 416 include peaks that are below threshold 408.

After significant peak areas 410, 412, 414, and 416 are identified, a visual indicator is computed for each identified peak. The bottom of FIG. 6 illustrates visual indicators calculated for each of peak areas 410, 412, 414, and 416. In some implementations, a kernel function is applied to each identified peak point. The kernel function is often a Gaussian kernel, though any suitable kernel function may be used. The width of the kernel can be specified by the user or a default value can be used. Curves 418, 420, 422, and 424 illustrate the area calculated by applying a kernel to each of peak areas 410, 412, 414, and 416, respectively. The larger the area calculated by the kernel, the more significant the peak area. For example, peak 414 is further below threshold 408 than peak 416, therefore the area under curve 422, which corresponds to peak 414, is larger than the area under curve 424, which corresponds to peak 416, indicating that peak 414 is more significant than peak 416. Also, peak area 412 includes two discrete peaks, 412a and 412b. The kernel areas calculated for each of peaks 412a and 412b overlap, such that the area under curve 420, which corresponds to peak area 412, is much larger than the kernel area calculated for a peak area with a single peak, such as the area under curve 418, which corresponds to peak 410.

A visual indicator may then be assigned to the kernel areas. Larger areas are assigned a visual indicator indicating greater significance than smaller areas. For example, larger areas may be assigned greater brightness in a gray-scale as illustrated in FIG. 1 or a red color in a color scale, while smaller areas may be assigned lesser brightness or a green or blue color. The assigned visual indicators may then be displayed in a peak detection ring, for example the peak detection ring 110 illustrated in FIG. 1, at the time interval(s) corresponding to the peak area identified with each calculated kernel area.

Though FIGS. 4, 5, and 6 illustrate identifying significant peak areas and calculating visual indicators for the identified peak areas for a single attribute, the technique illustrated in FIGS. 4, 5, and 6 may be generalized across multiple attributes. For example, when peaks in multiple attributes are identified during a given time interval, the peak detection areas calculated for each of the peaks across the different attributes will overlap, resulting in a larger kernel area which is assigned a visual indicator indicating greater significance than a time interval with an identified peak in just one attribute.

FIG. 7 is a block diagram of an example system 500 that includes a peak detection ring visualization module 502 executable on one or more processors 504. A processor can include a microprocessor, microcontroller, processor module or subsystem, programmable integrated circuit, programmable gate array, or another control or computing device.

The peak detection ring visualization module 502 is able to perform processes discussed above, including the processes of FIGS. 2 and 3, for example. The processor(s) 504 can be connected to a network interface 506 to communicate over a network and can be connected to a storage medium or storage media 508. The storage medium 508 can store a data set 510, such as a data set of data records. Data set 510 can include data points that are continually received by system 500, where such continually-received data points are visualized in real-time using the peak detection ring visualization module 502.

The storage medium (or storage media) 508 can be implemented as one or multiple computer-readable or machine-readable storage media. The storage media may include different forms of memory including semiconductor memory devices such as dynamic or static random access memories (DRAMs or SRAMs), erasable and programmable read-only memories (EPROMs), electrically erasable and programmable read-only memories (EEPROMs), and flash memories; magnetic disks such as fixed, floppy, and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media are considered to be part of an article (or article or manufacture). An article or article of manufacture can refer to any manufactured single component or multiple components. The storage medium or media can be located either in the machine running the machine-readable instructions, or located at a remote site from which the machine-readable instructions can be downloaded over a network for execution.

Various other adaptations, modifications, and combinations of features of the examples disclosed are within the scope of the invention Implementations may be practiced without some or all of the details disclosed. Numerous examples are encompassed by the following claims.

What is claimed is:

1. A method executed by a system having a processor, comprising:
arranging, into a plurality of data rings, pixels representing attributes, wherein each data ring contains pixels representing a time series of attribute values for a respective one of the attributes; and
providing a peak detection ring, wherein the peak detection ring comprises visual indicators for indicating a location of at least one peak in an attribute in the plurality of data rings.

2. The method of claim 1 further comprising assigning colors to pixels in a particular one of the plurality of data rings according to values of the attribute.

3. The method of claim 1 wherein arranging further comprises temporally aligning the pixels in the plurality of data rings and in the peak detection ring such that pixels along a particular radial axis are for a same time interval in different ones of the plurality of data rings.

4. The method of claim 1 wherein the visual indicators comprise different brightness for indicating different peak values.

5. The method of claim 1 wherein the visual indicators comprise different brightness for indicating different densities of peaks across the plurality of data rings.

6. The method of claim 1 wherein providing a peak detection ring comprises:
detecting at least one peak point in the attributes that is higher or lower than a threshold;
computing a visual indicator for each detected peak point; and
displaying the computed visual indicators on the peak detection ring.

7. The method of claim 6 further comprising receiving a selection of the threshold.

8. The method of claim 6 wherein computing a visual indicator for each detected peak point comprises applying a Gaussian kernel to each detected peak point.

9. The method of claim 1 wherein the peak detection ring is displayed as an outermost ring around the plurality of data rings.

10. An article comprising at least one computer-readable storage medium storing instructions that upon execution cause a system to:
generate a ring-based graphical visualization having a plurality of data rings for respective ones of a plurality of attributes;
place pixels representing the attributes into the data rings, where the pixels placed into a particular one of the plurality of rings correspond to a respective one of the attributes, and where the pixels are arranged in each of the data rings according to time intervals;
determine at least one peak in an attribute represented in one of the plurality of data rings; and
provide a peak detection ring, where the peak detection ring has visual indicators for indicating a location of the at least one peak in an attribute represented in the plurality of data rings.

11. The article of claim 10 wherein the instructions upon execution cause the system to further assign colors to pixels in a particular one of the plurality of data rings according to values of the attribute.

12. The article of claim 10 wherein the instructions upon execution cause the system to further temporally align the pixels in the plurality of data rings and in the peak detection ring such that pixels along a particular radial axis are for a same time interval in different ones of the plurality of data rings.

13. The article of claim 10 wherein the instructions upon execution cause the system to further display different brightness for different peak values on the peak detection ring.

14. The article of claim 10 wherein the instructions upon execution cause the system to further:
detect at least one peak point in the attributes that is higher or lower than a threshold;
compute a visual indicator for each detected peak point; and
display the computed visual indicators on the peak detection ring.

15. The article of claim 10 wherein the instructions upon execution cause the system to further:
receive a user selection of an upper and a lower threshold;
detect at least one peak that is higher than the upper threshold or lower than the lower threshold;
compute a visual indicator for each detected peak point; and
display the computed visual indicators on the peak detection ring.

16. The article of claim 10 wherein the instructions upon execution cause the system to further:
detect at least one peak point in the data records that is higher or lower than a threshold;
apply a Gaussian kernel to each detected peak point to compute a visual indicator for each detected peak point; and
display the computed visual indicators on the peak detection ring.
